(19) United States
(12) Patent Application Publication
(10) Pub. No.: US 2017/0010810 A1
(43) Pub. Date: Jan. 12, 2017

(54) Method and Apparatus for Providing Wear Leveling to Non-Volatile Memory with Limited Program Cycles Using Flash Translation Layer

(71) Applicant: Yiren Ronnie Huang, San Jose, CA (US)

(72) Inventor: Yiren Ronnie Huang, San Jose, CA (US)

(73) Assignee: CNEXLABS, Inc. a Delaware Corporation, San Jose, CA (US)

(21) Appl. No.: 15/203,702

(22) Filed: Jul. 6, 2016

Related U.S. Application Data
(60) Provisional application No. 62/189,132, filed on Jul. 6, 2015.

(51) Int. Cl. G06F 3/06; G06F 12/02

(52) U.S. Cl. CPC G06F 3/061; G06F 3/0688; G06F 3/0655; G06F 12/0246; G06F 2212/7211

(57) ABSTRACT

A solid-state drive (“SSD”), in one embodiment, uses a flash translation layer (“FTL”) to implement a wear leveling scheme for improving reliability of non-volatile memory (“NVM”). The SSD, which is a digital processing system operable to store information, includes a digital processing element and NVM device(s). The digital processing element which can be a memory controller is able to facilitate processing and storing data in the NVM device. The NVM device, in one embodiment, is divided the storage space into multiple blocks and each block is further organized in multiple minimum writeable units (“MWUs”) with a mapping table. While MWUs can be pages, the mapping table or address mapping table facilitates address association or map between MWUs and logic block addresses (“LBAs”) in accordance with a predefined wear leveling scheme.

### PRIORITY

This application claims the benefit of priority based upon U.S. Provisional patent application having an application No. 62/189,132, filed on Jul. 6, 2015, and entitled “Method and Apparatus for Providing Flash Translation Layer (FTL) Processing for Wear Leveling in Phase Change Memory (PCM) Based SSD,” which is hereby incorporated herein by reference in its entirety.

### FIELD

The exemplary embodiment(s) of the present invention relates to the field of semiconductor and integrated circuits. More specifically, the exemplary embodiment(s) of the present invention relates to non-volatile memory storage and devices.

### BACKGROUND

A typical solid-state drive (“SSD”), which is also known as a solid-state disk, is a data storage memory device for persistently remember stored information or data. Conventional SSD technology employs standardized interfaces or input/output (“I/O”) standards that may be compatible with traditional I/O interfaces for hard disk drives. For example, the SSD uses non-volatile memory components to store and retrieve data for a host system or a digital processing device via standard I/O interfaces.

To store data persistently, various types of non-volatile memories such as flash based or phase change memory (“PCM”) may be used. The conventional flash memory capable of maintaining, erasing, and/or reprogramming data can be fabricated with several different types of integrated circuit (“IC”) technologies such as NOR or NAND logic gates with floating-gates. PCM, which is also known as PCME, PRAM, PCRAM, Chalcogenide RAM, or ovonic unified memory, may use its state between the crystalline and amorphous state to store information. For instance, an amorphous state may indicate logic 0 with high resistance while a crystalline state may indicate logic 1 with low resistance.

A drawback associated with conventional non-volatile memory (“NVM”), however, is that it has a limited lifespan due to its limited number of program/erase (“PIE”) cycles. For instance, a typical NVM cell can have a range of up to approximately one million P/E cycles. Another problem associated with NVM is that uneven usage of minimum writable units within a block memory can further degrade the lifespan or efficiency of NVM.

### SUMMARY

One embodiment of the present invention discloses a solid-state drive (“SSD”) uses a flash translation layer (“FTL”) to implement a wear leveling scheme for improving reliability of non-volatile memory (“NVM”). The SSD, which is a digital processing system operable to store information, includes a digital processing element and NVM device(s). The digital processing element which can be a memory controller is able to facilitate processing and storing data in the NVM device. The NVM device, in one embodiment, is divided the storage space into multiple blocks and each block is further organized in multiple minimum writeable units (“MWUs”) with a mapping table. While MWUs can be pages, the mapping table or address mapping table facilitates address association or map between MWUs and logic block addresses (“LBAs”) in accordance with a predefined wear leveling scheme.

Additional features and benefits of the exemplary embodiment(s) of the present invention will become apparent from the detailed description, figures and claims set forth below.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a NV storage or NVM device configured to facilitate a wear leveling scheme to a word addressable NVM array in accordance with one embodiment of the present invention;

FIG. 2 is a logic block diagram illustrating a system having a mapping table capable of mapping LBA to PPA in accordance with one embodiment of the present invention;

FIG. 3 shows block diagrams illustrating memory block(s) and minimum writeable units in accordance with one embodiment of the present invention;

FIG. 4 is a block diagram illustrating an exemplary NVM block using mapping table to perform a method of wear leveling in accordance with one embodiment of the present invention;

FIG. 5 shows exemplary NVM blocks illustrating a data merging technique for data integrity and wear leveling in accordance with one embodiment of the present invention;

FIG. 6 is a diagram illustrating an NVM storage device configured to quickly store and/or recover FTL database using an FTL index table in accordance with one embodiment of the present invention;

FIG. 7 is a logic diagram illustrating a process of using FTL index table to store and restore the FTL database containing wear leveling information in accordance with one embodiment of the present invention;

FIG. 8 is a logic diagram illustrating a process of using a set of dirty and/or valid bits to update the FTL database in accordance with one embodiment of the present invention;

FIG. 9 is a flow diagram illustrating a process of providing wear leveling to NVM using the FTL database or table in accordance with embodiments of the present invention; and

FIG. 10 shows an exemplary embodiment of a digital processing system connecting to an SSD using wear leveling in accordance with the present invention.

### DETAILED DESCRIPTION

Exemplary embodiments of the present invention is described herein in the context of a methods, system and apparatus of facilitating a wear leveling scheme to an SSD containing low latency NVM device(s).

Those of ordinary skills in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method.

In accordance with the embodiment(s) of present invention, the components, process steps, and/or data structures described herein may be implemented using various types of operating systems, computing platforms, computer programs, and/or general purpose machines. In addition, those of ordinary skills in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, PCM, Jump Drive, and the like), magnetic storage medium (e.g., tape, magnetic disk drive, and the like), optical storage medium (e.g., CD-ROM, DVD-ROM, paper card and paper tape, and the like), phase change memory (“PCM”) and other known types of program memory.

The term “system” is used generically herein to describe any number of components, elements, sub-systems, devices, packet switch elements, packet switches, routers, networks, computer and/or communication devices or mechanisms, or combinations of components thereof. The term “computer” is used generically herein to describe any number of computers, including, but not limited to personal computers, embedded processors and systems, control logic, ASICs, chips, workstations, mainframes, etc. The term “device” is used generically herein to describe any type of mechanism, including a computer or system or component thereof. The terms “task” and “process” are used generically herein to describe any type of running program, including, but not limited to a computer process, task, thread, executing application, operating system, user process, device driver, native code, machine or other language, etc., and can be interactive and/or non-interactive, executing locally and/or remotely, executing in foreground and/or background, executing in the user and/or operating system address spaces, a routine of a library and/or standalone application, and is not limited to any particular memory partitioning technique. The steps, connections, and processing of signals and information illustrated in the figures, including, but not limited to the block and flow diagrams, are typically performed in a different serial or parallel ordering and/or by different components and/or over different connections in various embodiments in keeping within the scope and spirit of the invention.

One embodiment of the present invention discloses a system coupling to a solid-state drive (“SSD”) for storing data. The solid-state drive (“SSD”), in this embodiment, uses a flash translation layer (“FTL”) to implement a wear leveling scheme for improving reliability of non-volatile memory (“NVM”). The SSD, which is a digital processing system operable to store information, includes a digital processing element and NVM device(s). The digital processing element which can be a memory controller is able to facilitate processing and storing data in the NVM device. The NVM device, in one embodiment, is divided the storage space into multiple blocks and each block is further organized in multiple minimum writeable units (“MWUs”) with a mapping table. While MWUs can be pages, the mapping table or address mapping table facilitates address association or map between MWUs and logic block addresses (“LBAs”) in accordance with a predefined wear leveling scheme.

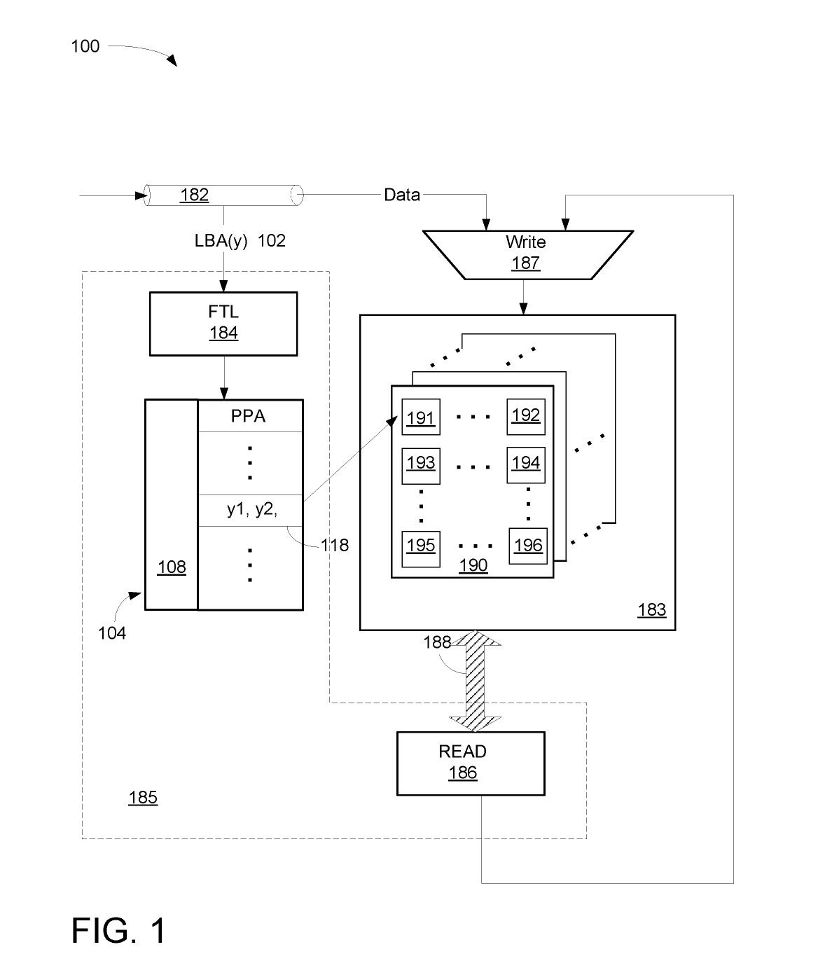

FIG. 1 is a block diagram 100 illustrating a NV storage or NVM device configured to facilitate a wear leveling scheme to a word addressable NVM array in accordance with one embodiment of the present invention. The terms NV storage, NVM device, and NVM array are referred to a similar non-volatile memory apparatus and they can be used interchangeably. Diagram 100 includes input data 182, NVM device 183, output port 188, and storage controller 185. Storage controller 185 can also be referred to as memory controller, controller, and storage memory controller, and they can be used interchangeably hereinafter. Controller 185, in one embodiment, includes read module 186, write module 187, FTL 184, LBA-PPA address mapping component 104, and wear leveling component (“WLC”) 108. A function of FTL 184 is to map logical block addresses (“LBAs”) to physical page addresses (“PPAs”) when a command of memory access is received. It should be noted that the underlying concept of the exemplary embodiment(s) of the present invention would not change if one or more blocks (or devices) were added to or removed from diagram 100.

A flash memory based storage device such as SSD, for example, includes multiple arrays of flash memory cells for storing digital information. The flash memory, which generally has a read latency less than 100 microseconds (“μs”), is organized in blocks and pages wherein a page is a minimum writeable unit or MWU. In one example, a page may have four (4) kilobyte (“Kbyte”), eight (8) Kbyte, or sixteen (16) Kbyte memory capacity depending on the technology and applications. It should be noted that other types of NVM, such as phase change memory (“PCM”), magnetic RAM (“MRAM”), STT-MRAM, or ReRAM, can have similar storage organization as the flash memory. To simplify the forgoing discussion, the flash memory is used as an exemplary NVM device. Also, a page or flash memory page (“FMP”) with 4 Kbyte is used as an exemplary page capacity.

NVM device 183, in one aspect, includes multiple blocks 190 wherein each block 190 is further organized to multiple pages 191-196. Each page such as page 191 can store 4096 bytes or 4 Kbyte of information. In one example, block 190 can contain from 128 to 512 pages or sectors 191-196. A page can be a minimal writable unit which can persistently retain information or data for a long period of time without power supply.

FTL 184, which may be implemented in DRAM, includes a FTL database or table that stores information relating to address map. For example, the size of FTL database is generally a positive proportion to the total size of NVM capacity. To implement the FTL, memory controller 185, for example, allocates a portion of DRAM having a size that approximately equals to 1/1000 of the total NVM capacity. For example, if a page is 4 Kbyte storage space and an entry of FTL database is 4 byte, the size of FTL database can be calculated as NVM capacity/4 KByte*4 Byte (NVM capacity/1000) which is approximately 1 over 1000 (or 1/1000).

Memory controller 185, in one embodiment, manages FTL 184, write module 187, read module 186, mapping component 104, and WLC 108. Mapping component 104 is configured to facilitate address translation between logic address used by a host system and physical address used by NVM device. For example, LBA(y) 102 provided by the host system may be mapped to PPA 118 pointing to a PPA in the NVM device based on a predefined address mapping algorithm as well as wear leveling factors.

To enhance lifespan of NVM, WLC 108 is employed to facilitate the mapping between LBAs and PPAs while considering wear leveling factor for address mapping. For example, WLC 108 is used to avoid direct mapping the same LBA to the same PPA. While dynamic wear leveling, static wear leveling, or combination of dynamic and static wear leveling scheme may be used, WLC 108 is operated under FTL 184 to assist generating of mapping tables that contains the wear leveling information in NVM device 183.

In operation, upon receipt of data input or data packets 182, FTL 184 maps LBA(y) 102 to a PPA which points to a physical storage location or page in NVM device 183. After identifying the PPA, write circuit 187 writes the data from data packets 182 to a page or pages pointed by the PPA in NVM device 193. After storing data at a block such as block 190, a corresponding wear leveling information is also stored in block 190. Note that the data stored in NVM or storage device 183 may be periodically refreshed using read and write modules 186-187.

Upon occurrence of unintended system power down or crash, the FTL database containing wear leveling information could be lost. The FTL database generally operates in DRAM and storage controller 185 may not have sufficient amount of time to save the entire FTL database before the power cuts off. Upon recovering of NVM device 183, the FTL database including wear leveling information needs to be restored or recovered before NVM device 183 can be accessed. In one embodiment, a technique of FTL snapshot and FTL index table is used for FTL restoration including information relating to wear leveling.

An advantage of employing WLC in FTL is that it can enhance overall NVM lifespan and efficiency.

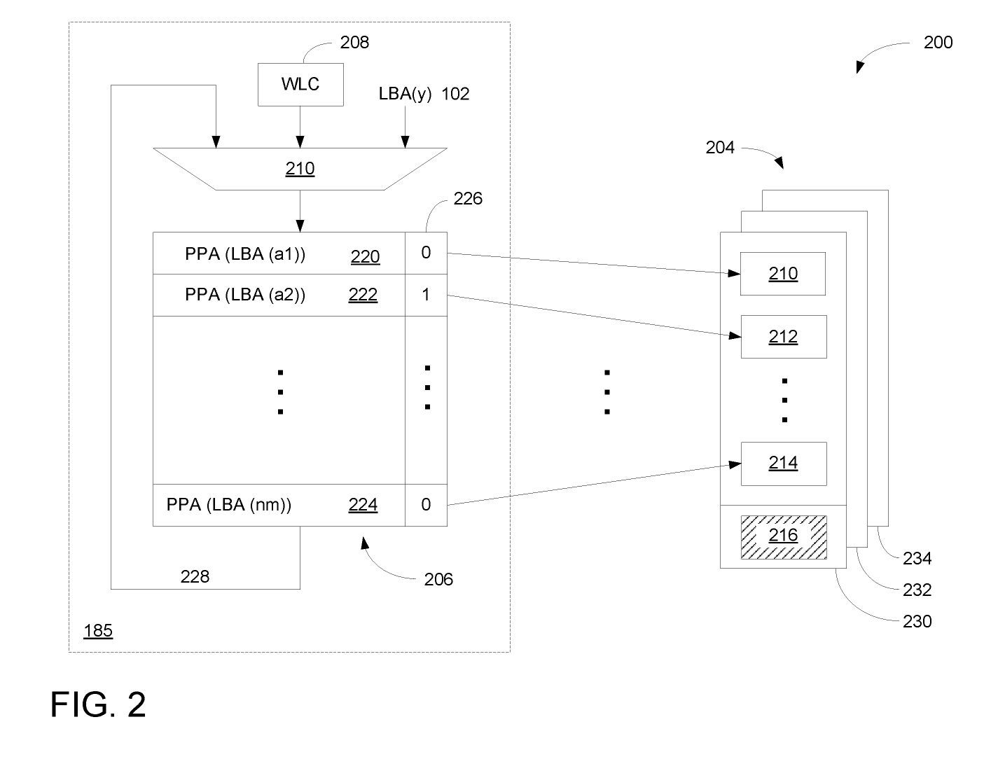

FIG. 2 is a logic block diagram 200 illustrating a system having a mapping table capable of mapping LBA to PPA in accordance with one embodiment of the present invention. Diagram 200 includes a digital processing system 185 and an NVM device 204. Digital processing system 185, which is a memory controller, includes WLC 208, mapping table 206, and address generator 210. A function of memory controller 185 is to facilitate processing and storing data between the SSD(s) and the host system(s). It should be noted that the underlying concept of the exemplary embodiment(s) of the present invention would not change if one or more blocks (or devices) were added to or removed from diagram 200.

NVM device 204 divides its storage space into memory blocks or blocks 230-234. Each block is further organized to have multiple minimum writeable units (“MWUs”) or pages 210-214 and at least one block address mapping table 216. Block address mapping table 216 of block 230, in one embodiment, includes multiple entries indicating mapping information between LBAs and PPAs 210 or 214 and wear leveling information about onboard NVM in block 230. In one embodiment, the scheme of wear leveling is implemented and managed by the FTL.

The FTL, not shown in FIG. 2, is resided in memory controller 185 capable of managing and/or facilitating implementation of the wear leveling scheme. The FTL, in one embodiment, includes WLC 208, address generator 210, and mapping table 206, wherein mapping table 206 further includes a set of dirty bits 226. A function of address generator 210 is to provide a physical address based on input address LBA(y) 102, WLC 208, and feedback from mapping table 206 as indicated by numeral 228. WLC 208, in one example, provides a predefined wear leveling scheme such as a dynamic wear leveling or static wear leveling. LBA(y) 102 is a logic address from the host system, not shown in FIG. 2, and is used to generate a physical address based on the algorithm used for address generation. The feedback from mapping table 206, in one embodiment, provides current information associated with PPA(s) in connection to the logic address. For example, the FTL should skip the old LBA valid entries indicated by dirty bits 226 when the LBA data is written into a physical block pointed by a PPA. Note that the physical block to be written can be either a new block or a stale block.

To store data persistently, the SSD employs memory controller 185 and NVM device 204 wherein controller 185 uses FTL to enhance overall NVM performance via implementation of wear leveling. In one embodiment, the NVM is a flash memory based storage device. Alternatively, the NVM can be a PCM or other NVM based storage device with low latency MWU addressable storage device. A function of address mapping table or mapping table 206 is to map a PPA to an LBA wherein the same LBA should not be mapped into the same PPA. Each block contains a PPA to LBA mapping table or block address mapping table 216 that reflects information for wear leveling relating to onboard NVM such as page 210.

Memory controller 185, in one embodiment, is also able to facilitate a process of garbage collection (“GC”) to recycle stale page into free page in accordance with GC triggering events, such as programming cycle count, minimum age of a block, and/or parity check(s). With the scanning capability, GC is able to generate a list of garbage block identifiers (“IDs”) or erasable block IDs and identify valid page IDs within the block or blocks.

NVM device 204, in one aspect, is divided into multiple blocks 230-234 wherein each block has a range of addressable pages 210-214. To enable data to be read from or be written to, memory controller 185 manages NVM read, write, and erase operations using FTL. The FTL uses a LBA to PPA mapping table 206 to manage the LBA to PPA mapping. For instance, when a host system attempts to repeatedly write to a particular logical address, the write-operation should write the data to different physical locations even though the LBA is the same. It should be noted that a used NVM block can be determined using one of several strategies, such as the amount of garbage content in the block, the programming cycle count, or a minimum age. Garbage collection can be applied to certain used blocks to transfer valid data pages in the used block to a new block. A stale copy of a determined garbage block can be re-written and RAID (redundant array of independent disks) parity can be regenerated if necessary.

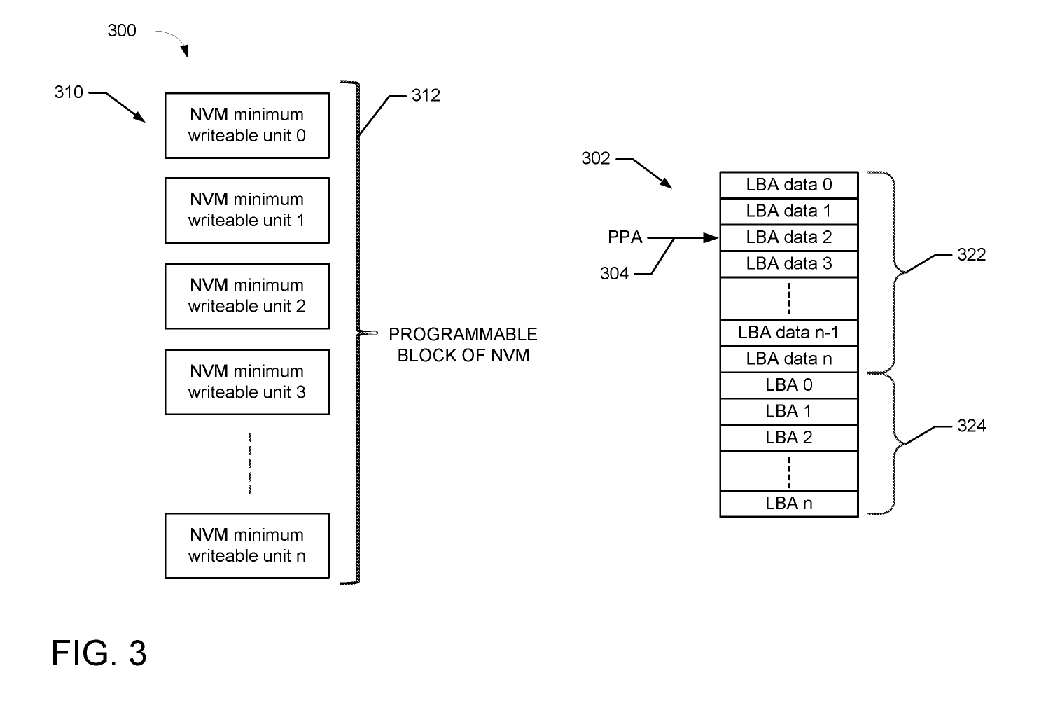

FIG. 3 shows block diagrams 300-302 illustrating memory block(s) and minimum writeable units in accordance with one embodiment of the present invention. Diagram 300 illustrates a set of NVM minimum writeable units 310 wherein each unit 310, also known as page, is the minimum amount of writing or reading bits by a host at one time. The number of the NVM minimum writeable units in a programmable block 312 is determined by the manageability of a management entry table. For example, in an exemplary embodiment, the management entry table is maintained in the NVM device. In an exemplary embodiment, the size of the block is determined by the number of blocks (NBLK), the capacity of the NVM (NVMcap), and the minimum writeable unit size (MlNunit). Thus, the number of blocks can be determined from the expression: (NBLK=NVMcap/MlNunit). For example, if the NVMcap is 16 GB, and MlNunit is 512B, then NBLK will be determined from (16 GB/(1K*512B)=32K blocks, where K=1000. If the management entry table identifies 32K blocks and each entry is 512 bits, then the size of the management entry table will be approximately 2 MB.

Diagram 302 shows an exemplary new or free NVM block that illustrates how sequential writes are performed in accordance with one embodiment of the present invention. In one embodiment, NVM array includes a data portion 322 containing multiple pages and a table portion 324 containing a block address mapping table. When data is to be written to a new block based address, an LBA associated with a memory access is mapped to a PPA 304. Each minimum writeable unit will have an LBA address and each LBA address will be mapped to a PPA pointing to a MWU or minimum writeable unit. If NVM memory array 302 is new, LBA data units are written into the physical block in a sequential order as illustrated. NVM memory array 302 also illustrates a PPA to LBA mapping table 324 located at the bottom portion of the block. PPA to LBA mapping table 324 is written to the block to reflect the mapping of the LBA to the PPA of the physical block.

An advantage of storing the PPA to LBA mapping table in an NVM block is that the mapping information can be maintained persistently without power supply.

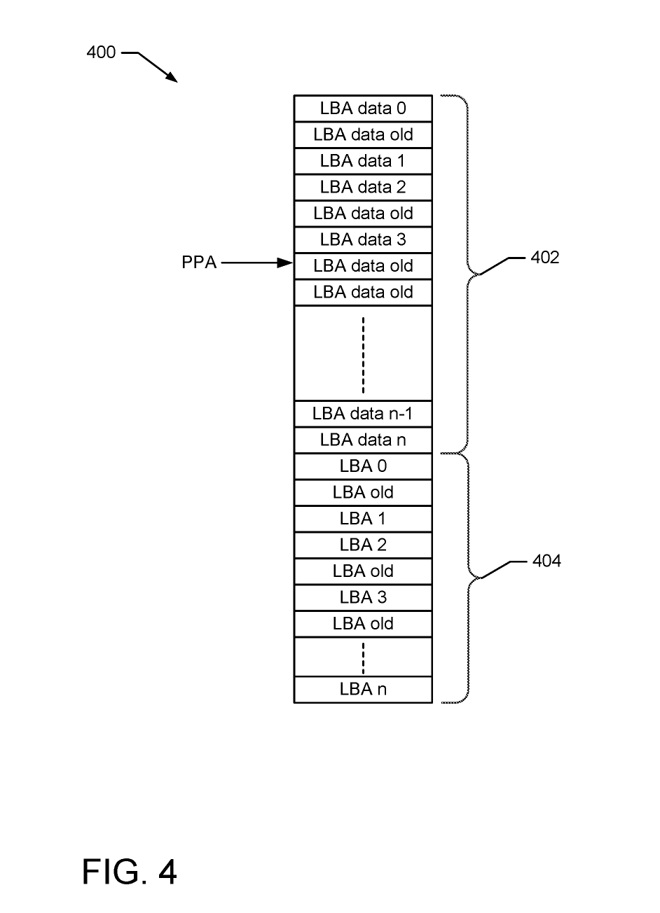

FIG. 4 is a block diagram 400 illustrating an exemplary NVM block using mapping table to perform a method of wear leveling in accordance with one embodiment of the present invention. The NVM block includes a storage section 402 and a table section 404. Storage section 402 is used to store data in accordance with the minimum writable units or pages. Table section 404 is used to store the block address mapping table which records mapping status within the block.

For example, when LBA data units are written into an old NVM block replacing some stale entries, the blocks to be written (i.e., free pages) should be selected to skip valid entries (i.e., old LBA entries). For example, new and old LBA data units are shown in storage section 402. It should be noted that whether an LBA data unit is valid or not is determined by the PPA to LBA mapping table. In an exemplary embodiment, a PPA to LBA mapping table (or lookup table) 404 is stored, saved, or recorded in every physical block of the NVM device. Note that whether the LBA data unit in a used NVM block is valid or not depends on a factor of match between the LBA and PPA using a current PPA. The last map between PPA and LBA is implied within the mapping table which is updated after the used block is written.

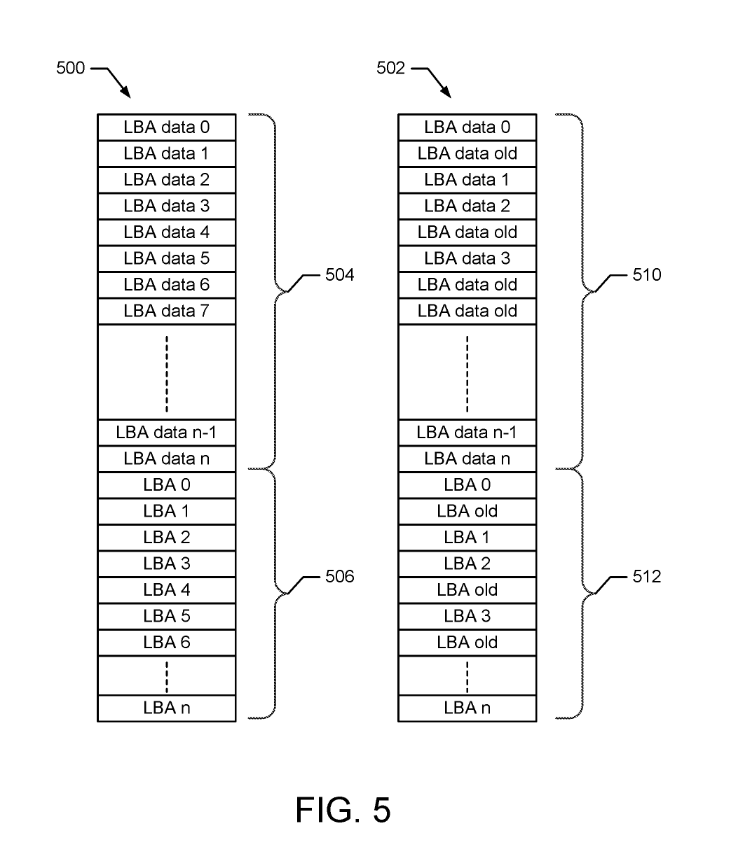

FIG. 5 shows exemplary NVM blocks 500-502 illustrating a data merging technique for data integrity and wear leveling in accordance with one embodiment of the present invention. Block 500 is a memory block containing a storage section 504 and a table section 506. Block 502 illustrates a memory block containing a storage section 510 and a table section 512. Block 502 illustrates an old block that contains new pages and old pager. In one embodiment, block 500 contains valid pages after merging.

In an exemplary embodiment, a mechanism to recover from power outages is provided. In one aspect, writes are performed to a new physical block 500 in a sequential order. For example, the new writes are shown at 504 and the associated mapping table is shown at 506. Then, the LBA data of this new block 500 is moved to an old block 502 by taking the valid entries of the new block 500 and moving them to stale entries of the older block 502, and if necessary, regenerate the RAID parity if any. For example, the old block 502 contains new entries and valid old entries 510 and the associated mapping table 512.

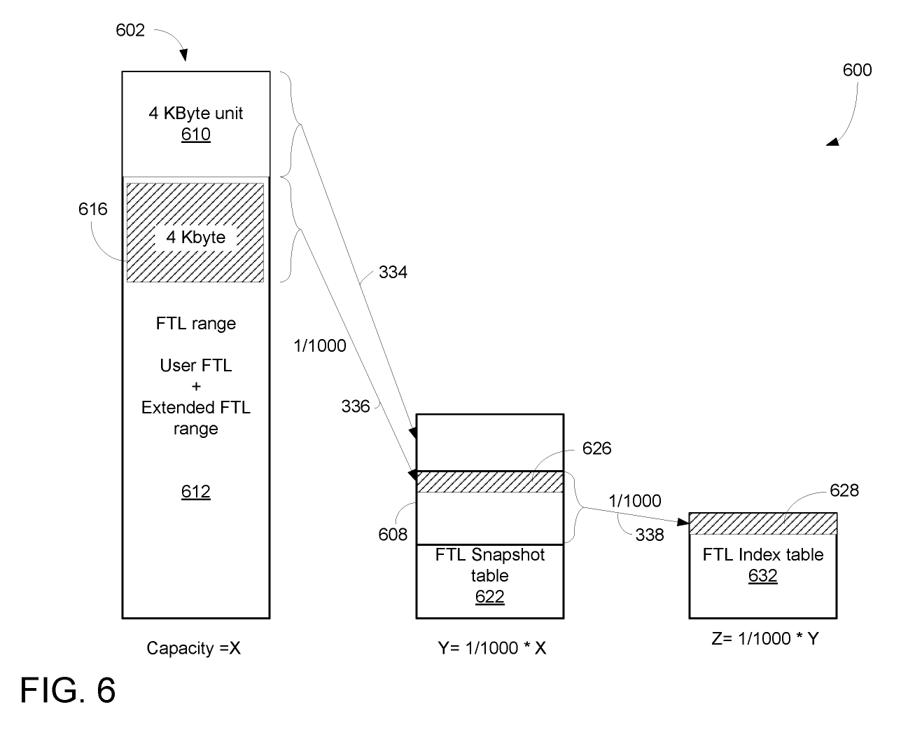

FIG. 6 is a diagram 600 illustrating an NVM storage device configured to quickly store and/or recover FTL database using an FTL index table in accordance with one embodiment of the present invention. Diagram 600 includes a storage area 602, FTL snapshot table 622, and FTL index table 632 wherein storage area 602 includes storage range 612 and an extended range 610. Storage range 612 can be accessed by user FTL plus extended FTL range. FTL snapshot table 606 is a stored FTL database at a giving time. In one embodiment, FTL snapshot table 606 is stored at extended FTL range 610 as indicated by numeral 334. It should be noted that the underlying concept of the exemplary embodiment(s) of the present invention would not change if one or more blocks (or components) were added to or removed from diagram 600.

Each entry of FTL database or FTL snapshot table such as entry 626 is set to a predefined number of bytes such as 4 bytes. Entry 626 of FTL snapshot table 622, in one example, points to 4 Kbyte data unit 616 as indicated by numeral 336. FTL snapshot table 622 is approximately 1/1024^{th} of the LBA range which includes user and extended ranges (or storage area) 612. If storage area 612 has a capacity of X, FTL snapshot table 622 is 1/1000 multiples with X. For example, if storage area 612 has a capacity of 512 gigabyte (“GB”), FTL snapshot table 622 should be approximately 512 megabyte (“MB”) which is 1/1000×512 GB.

FTL index table 632 is approximately 1/1024^{th} of FTL snapshot table 622 since each entry 628 of FTL index table 632 points to 4 Kbyte entry 608 of FTL snapshot table 622. If FTL snapshot table has a capacity of Y which is X/1000 where X is the total capacity of storage area 612, FTL index table 532 is 1/1000 multiples Y. For example, if FTL snapshot table 622 has a capacity of 512 MB, FTL index table 632 should be approximately 512 Kbyte which is 1/1000×512 MB.

In operation, before powering down the storage device, the FTL database or table is saved in FTL snapshot table 622. FTL index table 632 is subsequently constructed and stored in extended FTL range 610. After powering up the storage device, FTL index table 632 is loaded into DRAM of the controller for rebooting the storage device. Upon receiving an IO access with LBA for storage access, FTL index table 632 is referenced. Based on the identified index or entry of FTL index table 632, a portion of FTL snapshot table 622 which is indexed by FTL index table 632 is loaded from FTL snapshot table 622 into DRAM. The portion of FTL snapshot table is subsequently used to map or translate between LBA and PPA. In one aspect, FTL table or database is reconstructed based on the indexes in FTL index table 632. Rebuilding or restoring one portion of FTL database at a time can be referred to as building FTL table on demand, which improves system performance by using resources more efficiently.

An advantage of using an FTL index table is that it allows a storage device to boot up more quickly and accurately.

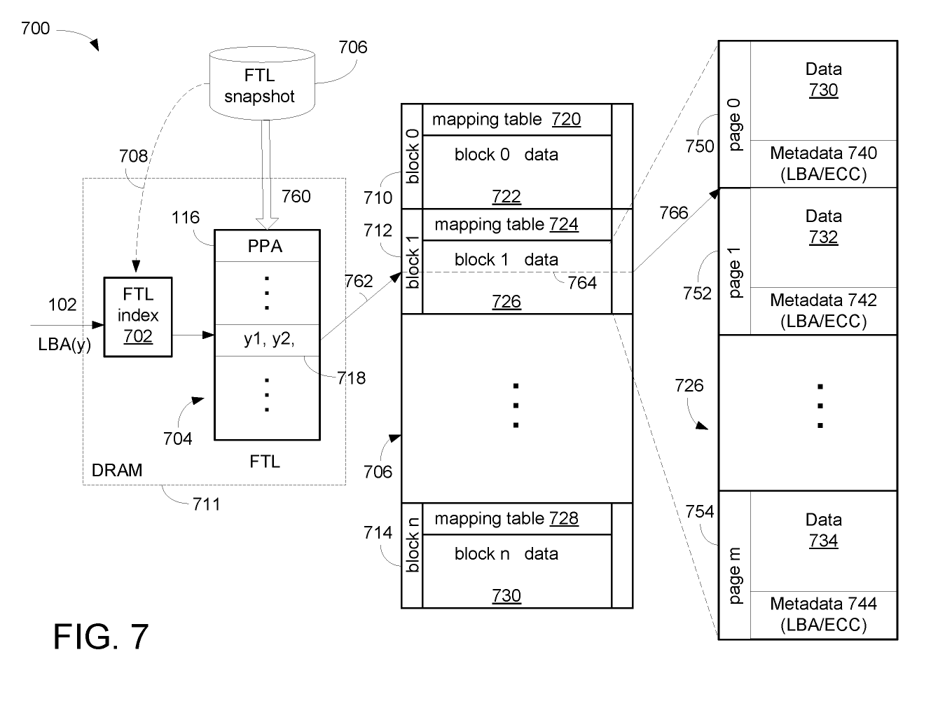

FIG. 7 is a logic diagram 700 illustrating a process of using FTL index table to store and restore the FTL database containing wear leveling information in accordance with one embodiment of the present invention. Diagram 700 includes a FTL database 704 and a storage device 706. Storage device 706 is structured to contain multiple blocks 710-714. It should be noted that the underlying concept of the exemplary embodiment(s) of the present invention would not change if one or more blocks (or components) were added to or removed from diagram 700.

Storage device 706, which can be flash memory based NV memory, contains blocks 710-714 organized as block 0 to block n. In one example, block 710 includes mapping table 720 and data storage 722. Block 712 includes mapping table 724 and data storage 726. Block 714 includes mapping table 728 and data storage 730. Block 0 to block n can be referred to as a user LBAs range, namespace, and/or logical unit number (“LUN”), where n is the size of the user LBA range or namespace. 0 to n sectors or blocks are the individual block or sector in the LBA range or namespace. While data storage 722 or 726 stores data or digital information, mapping tables 720 or 724 stores metadata such as wear leveling, sequence number, and error log. Data storage such as data storage 726 is further divided into multiple pages 750-754.

Block 712 of data storage 726, in one aspect, includes multiple pages 750-754 as page 0 through page m. For example, page 750 includes data section 730 and metadata section 740 wherein metadata 740 may store information relating to page 750 such as LBA, wear leveling, and error correction code (“ECC”). Similarly, page 752 includes data section 732 and metadata section 742 wherein metadata 742 may store information relating to page 752 such as wear leveling, LBA, and ECC. Depending on the flash technologies, each block can have a range of pages from 128 to 1024 pages.

FTL 704, in one embodiment, includes a database or table having multiple entries wherein each entry of database stores PPA associated with an LBA. For example, entry 718 of FTL 704 maps LBA(y) 102 to PPA pointing to block 712 as indicated by arrow 762. Upon locating block 712, page 752 is identified as indicated by arrows 762-766. It should be noted that one PPA can be mapped to multiple different LB As.

In one embodiment, diagram 700 includes FTL index table 702 which can be loaded into DRAM 711 for LBA mapping. FTL snapshot storage 706, in one embodiment, resides in the extended LBA range and contains FTL snapshot table and FTL index table 702. In operation, upon receiving a request for restoring at least a portion of FTL database after reactivating or rebooting a flash based NV storage device, FTL index table 702 containing indexes is retrieved from FTL snapshot storage 706. Each entry or index in FTL index table 702 points a unique portion of the FTL snapshot table. The unique portion of the FTL snapshot table can indicate a 4 Kbyte section of FTL database. In one example, FTL snapshot storage 706 is stored in a predefined index location of the NV storage device. After FTL index table 702 is loaded, a portion of the FTL database is restored in DRAM 711 in response to indexes in the FTL index table 702 and a recently arrived LBA associated with an IO access.

Since the FTL index table is 1/1000 of FTL snapshot table, the size of FTL index table is 512 KB. To boot the storage device, loading a 512 KB FTL index table into a volatile memory generally requires less than 5 milliseconds (“ms”) and consequently, the total boot time for booting the device should not take more than 100 ms.

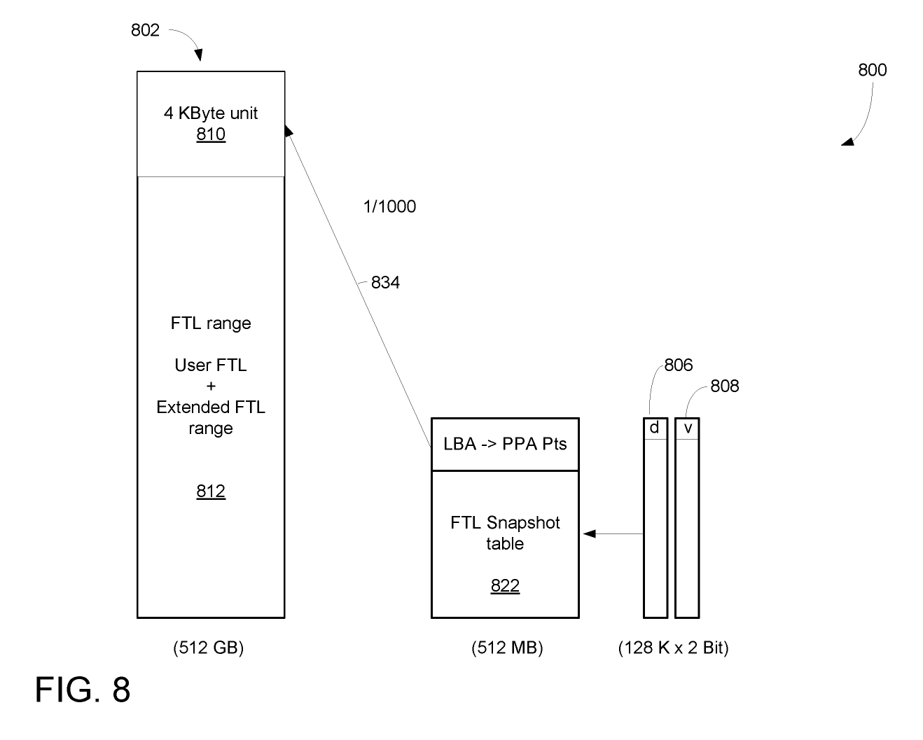

FIG. 8 is a logic diagram 800 illustrating a process of using a set of dirty and/or valid bits to update the FTL database in accordance with one embodiment of the present invention. Diagram 800 includes storage area 802, FTL snapshot table 822, and table of dirty bits 806 and valid bits 808. Storage area 802 includes storage range 812 and an extended range 810. In one embodiment, both FTL snapshot table 822 and table of dirty and valid bits 806-808 are stored in extended FTL range 810 as indicated by numeral 834. It should be noted that the underlying concept of the exemplary embodiment(s) of the present invention would not change if one or more blocks (or components) were added to or removed from diagram 800.

Dirty bits 806 and valid bits 808 are updated and/or maintained to indicate changes in the FTL database. For example, to identify which 4 Kbyte of FTL table needs to be rewritten to FTL snapshot table 722, dirty bits and/or valid bits are used to correspond entries in the FTL table that have been modified. Before powering down or during operation, portions of FTL table or database are selectively saved in FTL snapshot table 822 according to values of dirty bit(s) and/or valid bit(s).

When a snapshot of FTL database is properly saved in FTL snapshot table 722 before powering down, the FTL index table can be loaded into the system memory during the powering up. Upon an IO read request, the corresponding FTL snapshot is read from the flash memory based on indexes in the FTL index table. After the corresponding or portion of FTL database is loaded from FTL snapshot table 722, the portion of FTL database can be used for lookup in accordance with the IO read request. It should be noted that avoiding loading the entire FTL snapshot table from the flash memory into DRAM should allow the storage device to be boot up less than 100 ms.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

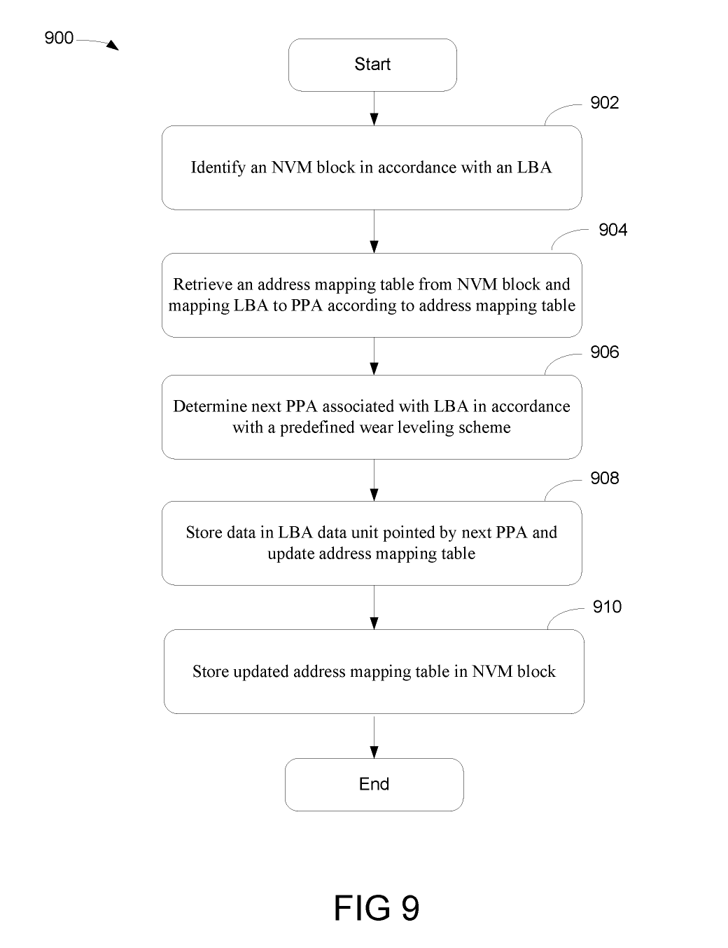

FIG. 9 is a flow diagram 900 illustrating a process of providing wear leveling to NVM device using the FTL database or table in accordance with embodiments of the present invention. At block 902, a process of storing data persistently is able to identify an NVM block in accordance with an LBA associated with a write commend.

At block 904, after retrieving an address mapping table from the NVM block, the LBA is mapped to a PPA in response to the information in the address mapping table or block address mapping table. At block 906, the process is capable of determining the next PPA associated with the LBA in accordance with a predefined wear leveling scheme. At block 908, upon storing data in an LBA data unit pointed by the next PPA, the address mapping table is updated to reflect the association between LBA and next PPA.

At block 910, the process stores the updated address mapping table in the NVM block. In one embodiment, a wear leveling logic associated with NVM is enabled to prevent storing data to the same storage location based on the LBA. The process is also able to enable FTL to implement dynamic wear leveling associated with NVM. Alternatively, the FTL is enabled by the controller to implement static wear leveling associated with NVM. In one embodiment, a garbage collection process can be activated to recycle stale writing units.

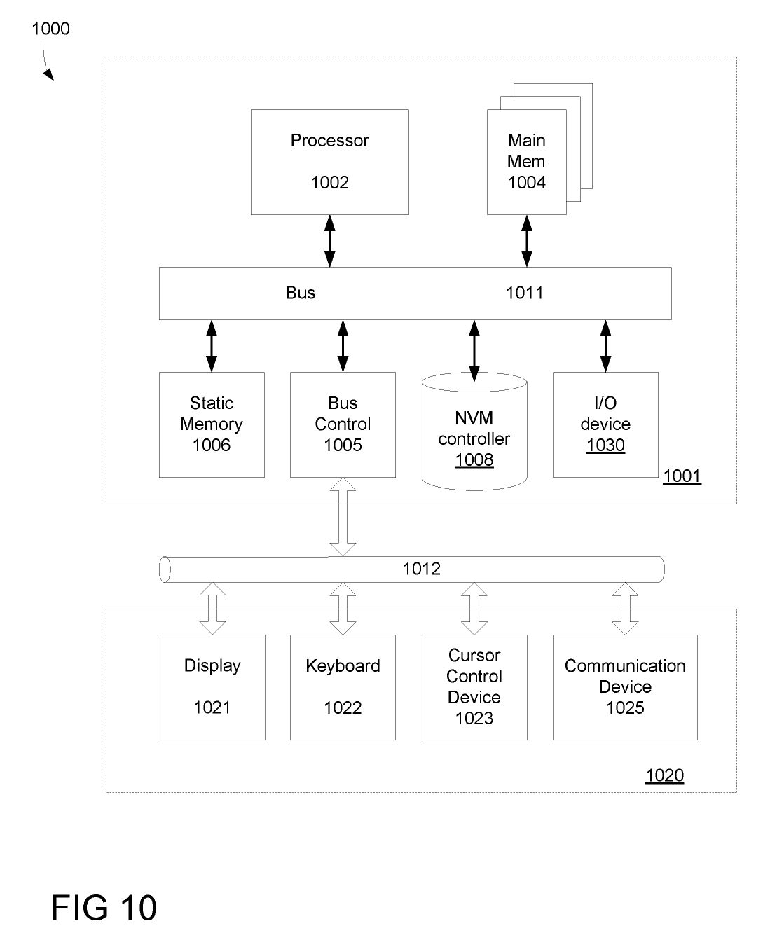

FIG. 10 shows an exemplary embodiment of a digital processing system or host system 1000 connecting to an SSD using wear leveling in accordance with the present invention. Computer system or a SSD system 1000 can include a processing unit 1001, an interface bus 1011, and an input/output (“IO”) unit 1020. Processing unit 1001 includes a processor 1002, main memory 1004, system bus 1011, static memory device 1006, bus control unit 1005, I/O device 1030, and SSD controller 1008. It should be noted that the underlying concept of the exemplary embodiment(s) of the present invention would not change if one or more blocks (circuit or elements) were added to or removed from diagram 1000.

Bus 1011 is used to transmit information between various components and processor 1002 for data processing. Processor 1002 may be any of a wide variety of general-purpose processors, embedded processors, or microprocessors such as ARM® embedded processors, Intel® Core™2 Duo, Core™2 Quad, Xeon®, Pentium™ microprocessor, Motorola™ 68040, AMD® family processors, or Power PC™ microprocessor.

Main memory 1004, which may include multiple levels of cache memories, stores frequently used data and instructions. Main memory 1004 may be RAM (random access memory), PCM, MRAM (magnetic RAM), or flash memory. Static memory 1006 may be a ROM (read-only memory), which is coupled to bus 1011, for storing static information and/or instructions. Bus control unit 1005 is coupled to buses 1011-1012 and controls which component, such as main memory 1004 or processor 1002, can use the bus. Bus control unit 1005 manages the communications between bus 1011 and bus 1012.

I/O unit 1030, in one embodiment, includes a display 1021, keyboard 1022, cursor control device 1023, and communication device 1025. Display device 1021 may be a liquid crystal device, cathode ray tube (“CRT”), touch-screen display, or other suitable display device. Display 1021 projects or displays images of a graphical planning board. Keyboard 1022 may be a conventional alphanumeric input device for communicating information between computer system 1000 and computer operator(s). Another type of user input device is cursor control device 1023, such as a conventional mouse, touch mouse, trackball, or other type of cursor for communicating information between system 1100 and user(s).

Communication device 1025 is coupled to bus 1011 for accessing information from remote computers or servers, such as server 104 or other computers, through wide-area network 102. Communication device 1025 may include a modem or a network interface device, or other similar devices that facilitate communication between computer 1100 and the network.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A digital processing system operable to store information, comprising:
a digital processing element able to process and store data;
a non-volatile memory (“NVM”) coupled to the digital processing element and configured to divide storage space into a plurality of memory blocks, each of the plurality of the memory blocks organized to include a plurality of minimum writeable units (“MWUs”) and an address mapping table, wherein the address mapping table includes multiple entries utilized to associate with at least some of the plurality of MWUs for wear leveling relating to the NVM.

2. The system of claim 1, further comprising a flash translation layer (“FTL”) coupled to the digital processing element and configured to facilitate implementation of the wear leveling.

3. The system of claim 2, wherein the FTL is resided in the digital processing element.

4. The system of claim 1, wherein the digital processing element is a NVM memory controller having a FTL capable of managing implementation of the wear leveling for the NVM.

5. The system of claim 1, wherein the system is a solid state drive (“SSD”).

6. The system of claim 1, wherein the NVM is a flash memory based storage device.

7. The system of claim 1, wherein the NVM is a phase change memory (“PCM”) or other NVM with limited program cycles based storage device.

8. The system of claim 1, wherein the NVM is low latency word addressable NVM storage device.

9. The system of claim 1, wherein each of the plurality of memory blocks is a minimum grouped programming unit.

10. The system of claim 1, wherein the address mapping table is a physical page address (“PPA”) to logic block address (“LBA”) mapping table configured to associate between a PPA and an LBA.

11. The system of claim 1, wherein each of the plurality of memory blocks contains a PPA to LBA mapping table containing information for facilitating implementation of wear leveling relating to the NVM.

12. The system of claim 1, wherein the digital processing element is able to facilitate a process of garbage collection to recycle stale page into free page in accordance with programming cycle count, minimum age of a block, parity check.

13. A method for persistently storing data, comprising:
identifying a non-volatile memory (“NVM”) block in accordance with a logic block address (“LBA”) associated with a write command;
retrieving an address mapping table from the NVM block and mapping the LBA to a physical page address (“PPA”) in response to information in the address mapping table;
determining a next PPA associated with the LBA in accordance with a predefined wear leveling scheme;
storing data in an LBA data unit pointed by the next PPA and updating the address mapping table to reflect an association between LBA and the next PPA; and
storing updated address mapping table in the NVM block.

14. The method of claim 13, further comprising enabling a wear leveling logic associated with NVM to prevent storing data to same storage location based on the LBA.

15. The method of claim 13, further comprising enabling a flash translation layer (“FTL”) to implement dynamic wear leveling associated with NVM.

16. The method of claim 13, further comprising enabling a flash translation layer (“FTL”) to implement static wear leveling associated with NVM.

17. The method of claim 13, further comprising activating a garbage collection process to recover stale writing units to free writing units.

18. A method for storing data in a non-volatile memory (“NVM”) device, comprising:
determining a physical page address (“PPA”) in accordance with a logic block address (“LBA”) based on an address mapping table modified in light of a predefined wear leveling scheme;
storing data in an NVM page pointed by the PPA and updating the address mapping table to reflect an association between LBA and the PPA and setting a dirty bit indicating an update to the address mapping table;
updating and storing the address mapping table in a flash translation layer (“FLT”) index table in an NVM block containing the NVM page before powering down the NVM device.

19. The method of claim 18, further comprising:
receiving a request for restoring at least a portion of FTL table after powering up the NVM device; and
retrieving the FTL index table containing a plurality of index entries wherein each entry of the plurality of the FTL index table points a unique portion of the FTL table from the NVM block in the NVM device.

20. The method of claim 19, further comprising restoring at least a portion of the FTL table in response to the FTL index table.
